(19) United States
(12) Patent Application Publication
(10) Pub. No.: US 2021/0244606 A1
(43) Pub. Date: Aug. 12, 2021

(54) CONFIGURABLE THERAPEUTIC ROLLER KIT AND APPARATUS, AND METHODS OF USING SAME

(71) Applicant: Leon R. CHEN, NOVI, MI (US)

(72) Inventor: Leon R. CHEN, NOVI, MI (US)

(21) Appl. No.: 17/166,298

(22) Filed: Feb. 3, 2021

Related U.S. Application Data
(60) Provisional application No. 62/971,964, filed on Feb. 8, 2020.

(51) Int. Cl. A61H 15/00

(52) U.S. Cl. CPC A61H 15/0092; A61H 2015/0042; A61H 2201/1635; A61H 2015/0064; A61H 2015/0014

(57) ABSTRACT

A massage roller apparatus includes a roller ball and a main roller body, which includes upper, lower and middle encasement members. The roller ball is hollow and contains a thermally stable material. The lower encasement member has a first concave opening therein, and an upper edge portion with a first attachment structure. The ring-shaped middle encasement member has a lower portion with a second attachment structure, and an upper portion with a third attachment structure. A hollow opening of the middle encasement member has a first diameter at its upper portion, and has a second diameter, less than the first diameter, at its lower portion. The upper encasement member includes a cup-shaped portion with a second concave opening therein, and also includes a handle at its upper end. A lower portion of the upper encasement member has a fourth attachment structure for selectively connecting to the middle encasement member.

### CROSS-REFERENCE TO RELATED APPLICATIONS

The present application is based on, and claims the benefit of priority under 35 USC 119 from U.S. Provisional Patent Application No. 62/971,964, filed Feb. 8, 2020. The entire contents the referenced priority application, including specification and drawings, are incorporated by reference herein.

### BACKGROUND OF THE INVENTION

### Field of the Invention

The present invention relates to a configurable therapeutic roller kit, to a configurable therapeutic roller apparatus, and to methods of using the kit and apparatus.

### Background Art

For anyone who undergoes a certain amount of physical activity, such as an athlete or a physical fitness aficionado, injuries may occur, and therapeutic and/or preventative measures must be taken so that such injuries heal and do not become worse.

Compressing (massaging), icing, or heating injuries are the most common methods of short-term treatment, and can provide several major benefits. However, the methods of delivering these treatments are tedious and can be time consuming.

In a case of icing an injury, for example, ice melts over a relatively short period of time, and the resulting water is difficult to contain and can cause a mess. Applying ice to injuries also does not provide the benefit of compression, which massages the injury location and prevents further swelling.

A number of different tools are known for use in therapeutic massage. Examples of some of these known tools include those described in U.S. Pat. D259,142, U.S. Pat. D272,090, U.S. Pat. D378,539, U.S. Pat. D501,257, U.S. Pat. D829,334, U.S. Pat. D870,908, U.S. Pat. No. 622,350, U.S. Pat. No. 1,844,247, U.S. Pat. No. 1,904,042, U.S. Pat. No. 4,722,326, U.S. Pat. No. 6,093,159, U.S. Pat. No. 7,399,285, and U.S. Pat. No. 7,481,783.

Although the known massage rollers and related tools are usable for their intended purposes, a need still exists in the art for improved therapeutic massage rollers and related methods.

### SUMMARY OF THE INVENTION

The present invention provides a configurable therapeutic massage roller apparatus, and in an alternate embodiment, provides a kit of components which may be assembled to form the apparatus, or to form other subassemblies which are discussed further herein.

The kit or apparatus hereof includes including a main roller body having several selectively connectable components made of a reasonably insulating material, such as plastic.

The main roller body includes a substantially cup-shaped lower encasement member, a modified goblet-shaped upper encasement member and a ring-shaped middle encasement member which is selectively attachable to either or both of the upper and lower encasement members.

The kit or apparatus also includes a hollow roller ball which fits nestingly inside of the main roller body. The roller ball is made of a heat-conductive material, which may be formed of a metal such as aluminum or stainless steel. The roller ball contains a thermally stable material which may be a refrigerant, such as any of the known materials used inside of re-usable ice packs.

The lower encasement member has a first concave opening formed therein and also has a flattened lower surface on a side opposite the first concave opening. The lower encasement member also has an upper edge portion with at least one first attachment structure thereon for connecting to the middle encasement member. The first attachment structure may include threads, a first part of a resilient plastic snap connector, a first part of a bayonet connection, or other known attachment structure.

The middle encasement member is a substantially cylindrical ring-shaped member having a hollow central opening formed therein. The middle encasement member also has a lower edge portion with a second attachment structure thereon for selectively connecting to the first attachment structure of the lower encasement member. The middle encasement member also has an upper edge portion with a third attachment structure thereon for selectively connecting to a fourth attachment structure of the upper encasement member;

The hollow central opening of the middle encasement member is formed with a tapered interior shape, having a first diameter at the upper edge portion thereof, and having a second diameter at the lower edge portion, where the second diameter is less than the first diameter.

This reduced diameter feature of the middle encasement member retains the roller ball within the assembled apparatus when the middle encasement member is attached to either the upper encasement member or to the lower encasement member with the roller ball therein.

The upper encasement member includes a cup-shaped portion having a second concave opening formed therein and having a handle attached to an upper end thereof. The upper encasement member has a lower edge portion with at least one fourth attachment structure thereon for connecting to the middle encasement member.

The roller ball is capable of being removed from the main roller body, and may be either heated or cooled to a desired target temperature. As further described in subsequent sections, the middle encasement member can be selectively connected to other components of the kit or apparatus to provide a massage roller apparatus which is usable to provide a therapeutic massage treatment to a patient.

Several advantages are associated with the use of a configurable apparatus described: to provide portability of a therapeutic massage configurable apparatus, to provide ergonomic handling of such a configurable apparatus, to provide user flexibility in the configurations in which the configurable apparatus can be used, and to enable the configurable apparatus to be utilized in a cold state for a relatively long amount of time.

The configurable therapeutic roller configurable apparatus according to the present invention provides a versatile solution to problems associated with massaging an injury and applying different temperatures to such injury.

Firstly, it is able to combine the benefit of a configurable athletic massage apparatus, in a manner comparable to a foam roller, and the added benefit of applying low or high temperatures to an injury. Secondly, it minimizes the hassle associated with handling a material such as ice, as described above. This means that it takes less effort to prepare, and there is no mess to clean up after the user finishes using the configurable apparatus.

Additionally, the configurable apparatus is portable, so that the user can easily store the configurable apparatus and bring it to an athletic event, a trip to the gym, etc. This is possible because the insulating aspect of the configurable apparatus minimizes heat transfer, keeping the configurable apparatus at a target temperature for long amounts of time.

Another beneficial property of this configurable apparatus is the ability for the user to manipulate the components into several configurations. This gives the user flexibility in how they would like to utilize the configurable apparatus, whether with a handle, without a handle, or in a modified form, with some other handle portion that gives the user better gripping ability.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a perspective view of a configurable therapeutic massage roller apparatus according to an illustrative embodiment of the invention.

FIG. 2 is an exploded perspective view of the configurable therapeutic massage roller apparatus of FIG. 1, showing each of the components thereof, also illustrating components of a kit according to the present invention. .

FIG. 3 is a translucent view of the roller ball component of the configurable apparatus fitted into the middle encasement member of the configurable apparatus.

FIG. 4 is a cross-sectional view of the middle encasement member.

FIG. 5 is a side plan view of a first massage roller apparatus with the upper encasement member attached to the middle encasement member with the roller ball enclosed therein.

FIG. 6 is a translucent detail side plan view, partially cut away, of the first massage roller apparatus of FIG. 5.

FIG. 7 is a perspective view of a second massage roller apparatus with the middle encasement member attached to the lower encasement member, with the roller ball enclosed therein; and.

FIG. 8 is a detail side plan view, partially cut away, of the second massage roller apparatus of FIG. 7.

### DETAILED DESCRIPTION OF ILLUSTRATIVE EMBODIMENTS

Throughout the present specification and claims, relative positional terms like ‘upper’, ‘lower’, ‘middle’, ‘front’, ‘rear’, ‘top’, ‘bottom’, ‘horizontal’, ‘vertical’, and the like are used to refer to the orientation of the apparatus as shown in the drawings. These terms are used in an illustrative sense to describe the depicted embodiments as shown, and are meant to illustrate, rather than to limit the invention.

It will be understood that the depicted apparatus may be placed at an orientation different from that shown in the drawings, such as inverted 180 degrees or transverse to that shown, and in such a case, the above-identified relative positional terms will no longer be accurate.

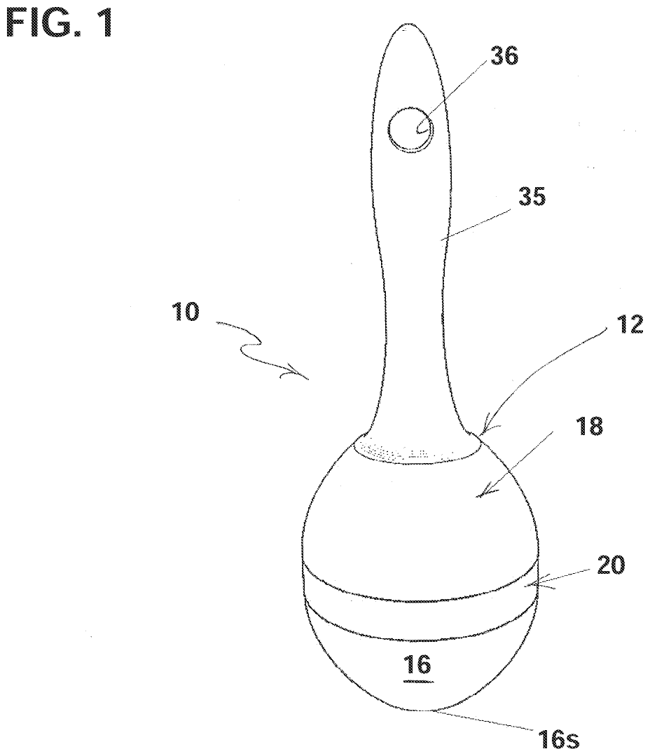

Referring now to the drawings, a configurable therapeutic massage roller apparatus, according to an illustrative embodiment of the invention, is shown generally at 10 in FIG. 1.

The apparatus 10 includes a main roller body 12, formed of several selectively connectable components which are made of a reasonably insulating material, such as plastic, and also includes a roller ball 14 which fits inside of the main roller body 12.

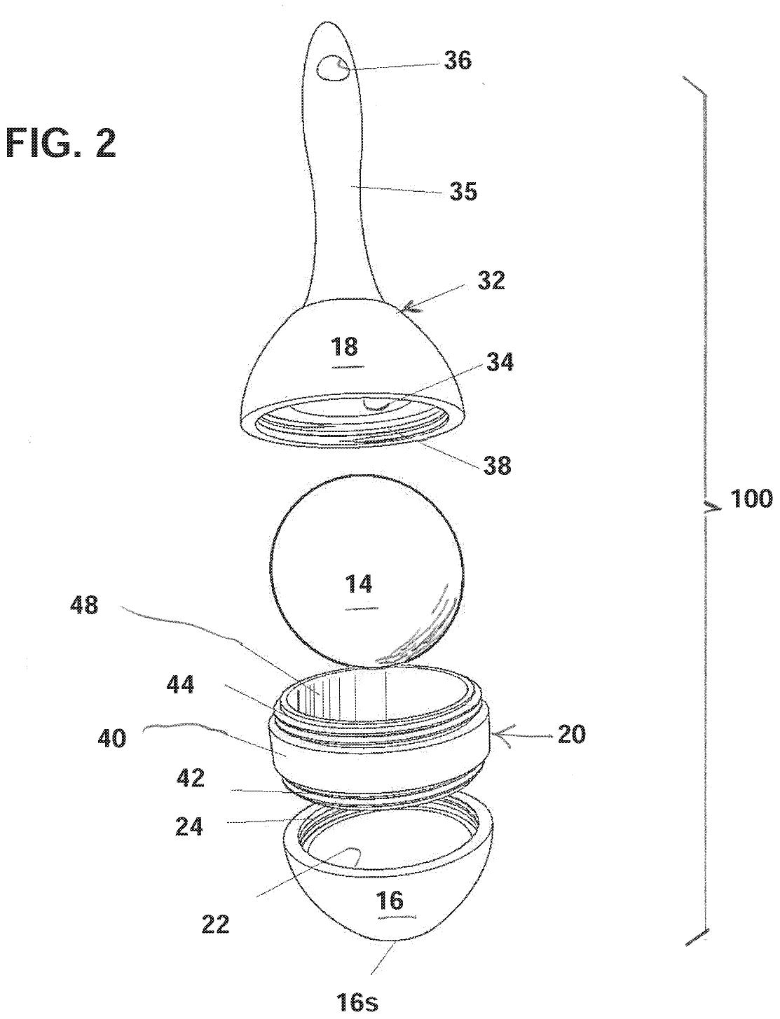

The present invention also relates to a kit 100 of components, shown separately in FIG. 2, which may be provided in unassembled form. Such a kit 100 may, optionally, be provided with a carrying case (not shown) and the components of the kit may be selectively assembled to form the apparatus 10, or other subassemblies which are discussed further herein.

As noted above, the kit 100 or apparatus 10 also includes a hollow roller ball 14, which fits inside of the main roller body 12.

FIG. 2 is an exploded view showing all components of the kit 100 or the configurable apparatus 10, including the main roller body 12 and the roller ball 14.

The main roller body 12 is hollow and includes an lower encasement member 16, a middle encasement member 20, and an upper encasement member 18. The main roller body 12 is made of materials capable of exhibiting heat insulating properties such as plastic, but any substitution with other materials having such properties may alternatively be used.

### Lower Encasement Member

The lower encasement member 16 has a flattened lower surface 16s which is provided so that the assembled apparatus 10 can stand statically. The lower encasement member 16 is a generally cup-shaped member having a concave socket 22 formed therein, and at an upper end thereof, the lower encasement member 16 is provided with a first attachment structure 24. In the depicted embodiment, the first attachment structure takes the form of female threads engraved around the inner circumference of the upper end, as shown.

### Middle Encasement Member

The middle encasement member 20 is generally in the form of a circular ring 40 which is extended by a second attachment structure 42 at the lower end thereof, and by a third attachment structure 44 at the upper end thereof. In the depicted embodiment, each of the second and third attachment structures takes the form of male threads engraved around the outer circumference of the lower and upper ends of the middle encasement member 20, as shown.

The middle encasement member is threadably engageable with the first attachment structure of the lower encasement member via either of the second attachment structure 42 or the third attachment structure 44 fitting into the first attachment structure, depending on the desired use of the kit 100 or apparatus 10.

An interior surface of the annular middle encasement member 20 forms a hollow cylindrical space 48 configured and dimensioned to receive a central portion of the roller ball 14.

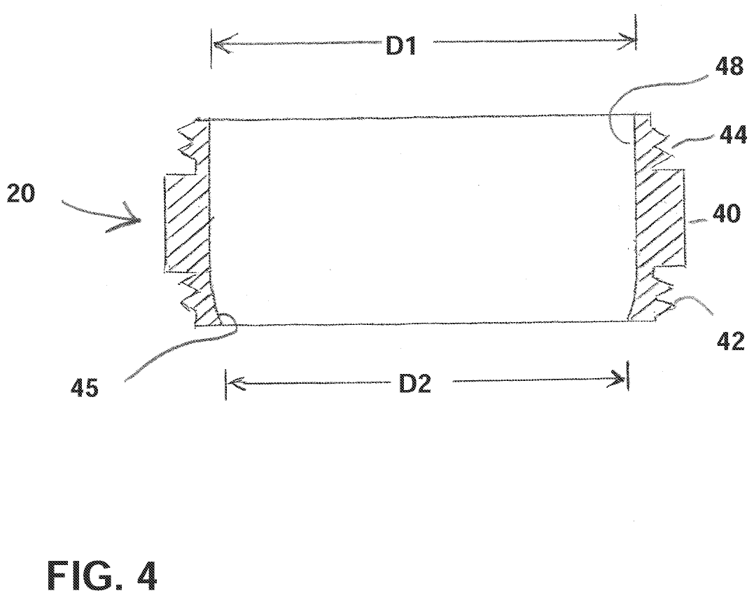

FIG. 4 is a cross-sectional view of the middle encasement member. The length D1 shown in FIG. 4, represents the diameter of the hollow cylindrical space 48 through the portions of the middle ring 40 and the third attachment structure 44, respectively. Both of these two diameters are equal to each other, and are incrementally larger than the diameter of the roller ball 240, so that the roller ball may fit part way through the hollow cylindrical space 48.

D2, however, represents a smaller diameter, by approximately several millimeters, at the narrowest part of the of the second attachment structure 42, which defines a narrow portion 45. This is because the hollow cylindrical space 48 begins to taper inwardly at the lower end of the middle encasement member 20, as shown, where the second attachment structure 42 is located, meaning that the inner surface of this ring is curved inwards so that when the widest part of the the roller ball 14 contacts the narrow portion 45, the roller ball 14 becomes obstructed and cannot completely pass through this part of the middle encasement member.

### Upper Encasement Member

The upper encasement member 18 is formed in an inverted modified goblet shape, as shown, including an inverted cup-like base portion 32 having a concave hollow socket 34 (FIG. 2) formed therein for receiving the roller ball 14.

In the depicted embodiment, the upper encasement member 18 also includes a handle portion 35 extending upwardly out of the base portion 32 on a side opposite the concave socket 34. The handle portion 35 could possibly have a hollow opening 36 formed therethrough to allow for hanging storage of the apparatus. The handle portion 35 could be made in a different shape as desired, such as in a grippable loop having projections extending inwardly thereon to fit between the fingers of a user.

The inverted cup-like base 32 has a fourth attachment structure 38 is provided inside of the concave socket 34 formed therein, and at the lower end of the base 32. In the depicted embodiment, the fourth attachment structure 38 takes the form of female threads engraved around the inner circumference of the lower end of the base 32, as shown.

### Roller Ball

The roller ball 14 is made of a material capable of exhibiting heat conducting properties such as a metal, but other alternative materials with such properties may also be used. The roller ball 14 has a substantially hollow interior so that it may enclose a substance with a high heat capacity, which is capable of absorbing quantities of heat energy.

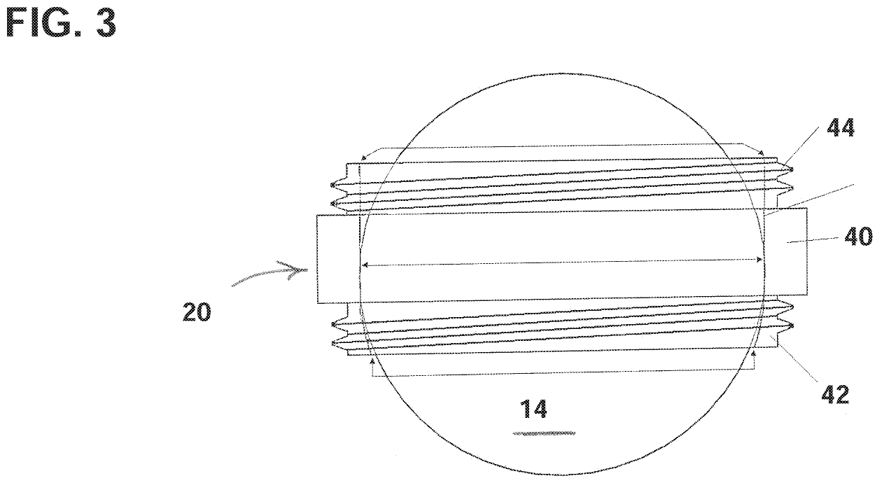

FIG. 3 is a translucent view of the middle encasement member 20 with the roller ball 14 fitted into the hollow cylindrical space 48, and as noted above, FIG. 4 is a cross-sectional view of the middle encasement member. FIG. 3 illustrates the situation where the roller ball 14 is obstructed and cannot completely pass through the narrow portion 45 of the middle encasement member 20.

### First Thereapeutic Massage Tool

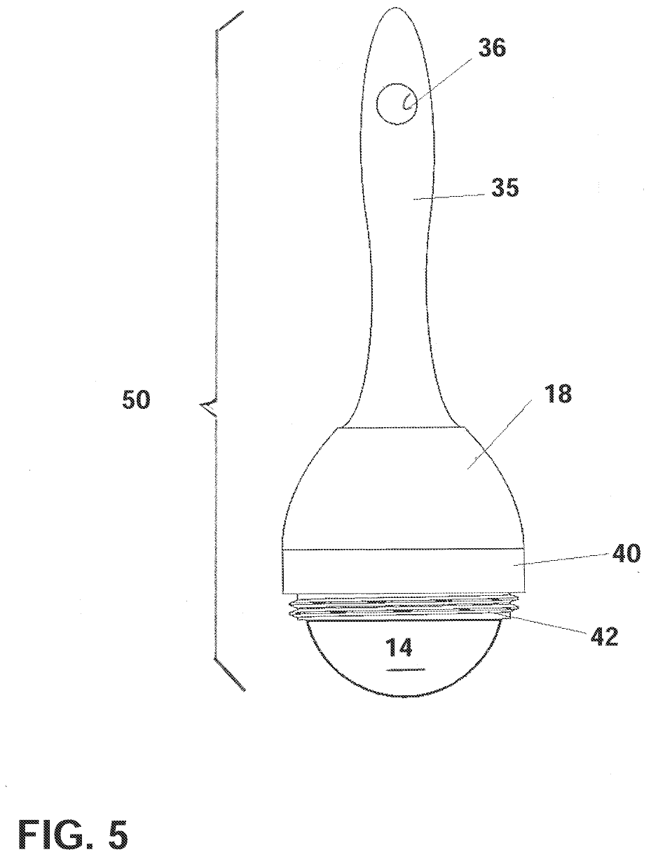

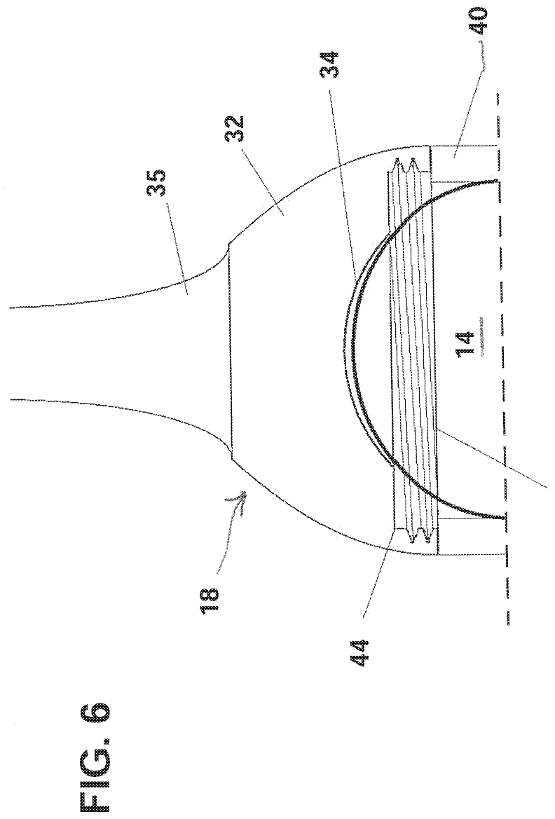

FIG. 5 is a side plan view of a first therapeutic massage tool 50 made using selected components of the kit 100 or apparatus 10 hereof, and FIG. 6 is a translucent detail view showing part of the tool 50 of FIG. 5. This tool 50 is made using the upper encasement member 18 attached to the middle encasement member 20, with the roller ball 14 enclosed within these two attached components.

In this tool 50, the lower encasement member 16 of the configurable apparatus 10 is removed, but the upper encasement member 18 and the middle encasement member 20 hold the roller ball 40 in place. The concave socket 34 of the inverted cup-like base 32 serves as a partial housing to supportively receive a portion of the roller ball 14 therein.

The inverted cup-like base 32 of the upper encasement member 18 contains the fourth attachment structure 38, which combines with the third attachment structure 44 of the middle encasement member 20. In the depicted embodiment, this is accomplished by engaging the male threads of the third attachment structure 44 into the female threads of the fourth attachment structure 38.

It is important to note that only an attachment between the third attachment structure 44 and the fourth attachment structure 38 specifically will allow for this configuration. This is because the portion of the middle encasement member having the third attachment structure thereon contains the correct diameter portion of the cylindrical space 48 configured and dimensioned to receive a central portion of the roller ball 14..

In the arrangement of the tool 50 shown in FIGS. 5-6, the lower end of the middle encasement member inside of the second attachment structure 42 includes the narrow portion which retains the roller ball 14 inside of the assembled tool.

### Second Thereapeutic Massage Tool

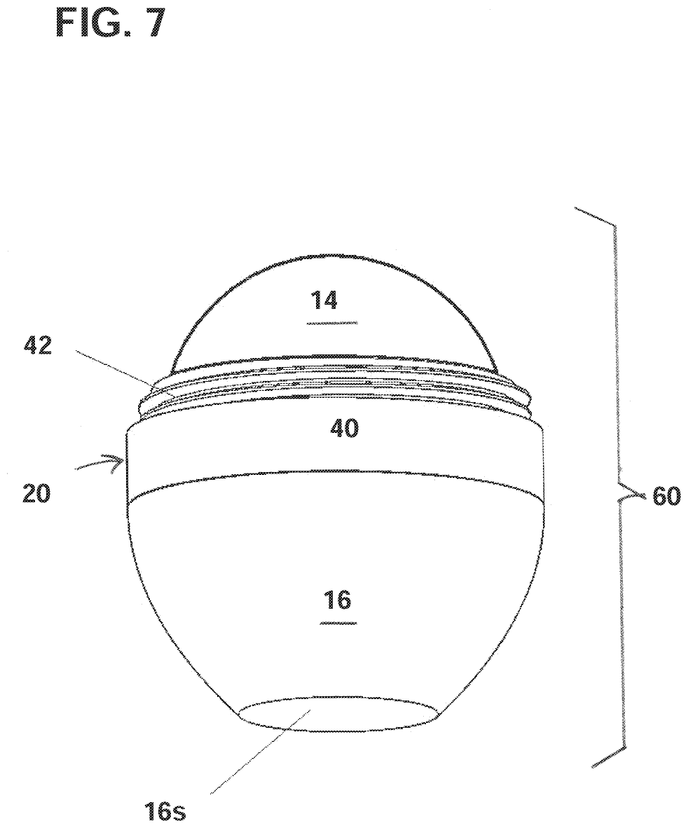

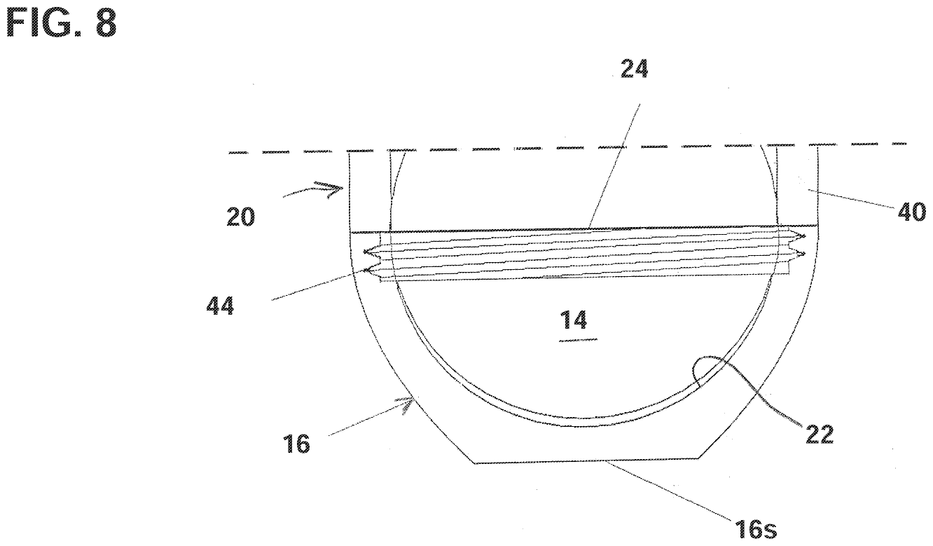

FIG. 7 is a perspective view of a second therapeutic massage tool 60 made using selected components of the kit 100 or apparatus 10 hereof, and FIG. 8 is a translucent detail view showing part of the tool 60 of FIG. 7. This tool 60 is made using the lower encasement member 16 attached to the middle encasement member 20, with the roller ball 14 enclosed within these two attached components. The concave socket 22, of the cup-shaped lower encasement member 16, serves as a partial housing to supportively receive a portion of the roller ball 14 therein.

The cup-shaped lower encasement member 16 contains the first attachment structure 24, which combines with the third attachment structure 44 of the middle encasement member 20. In the depicted embodiment, this is accomplished by engaging the male threads of the third attachment structure 44 into the female threads of the first attachment structure 24.

It is important to note that only an attachment between the third attachment structure 44 and the first attachment structure 24 specifically will allow for this configuration. This is because the portion of the middle encasement member having the third attachment structure 44 thereon contains the correct diameter portion of the cylindrical space 48 configured and dimensioned to receive a central portion of the roller ball 14..

In the arrangement of the tool 60 shown in FIGS. 7-8, the upper end of the (inverted) middle encasement member, inside of the second attachment structure 42, includes the narrow portion 45 which retains the roller ball 14 inside of the assembled tool.

### Operation

In operation, the roller ball 14 is heated or cooled until it reaches a desired temperature. When this is achieved, the user should then assemble the configurable apparatus into the either of the massage tools 50 or 60. This can be accomplished by manipulating either the upper encasement member 18, middle encasement member 20, or lower encasement member 16, such that the second attachment structure 42 of the middle encasement member 20 engages the fourth attachment structure the upper encasement member 18 or alternatively, that the second attachment structure 42 of the middle encasement member 20 engages the first attachment structure 24 of the lower encasement member 16, depending on the desired configuration.

When using the first tool 50, the user may hold the handle portion 35, and when using the second tool 60, the user may hold onto the combination of the middle encasement member 20 and lower encasement member 16. In either case, the user can apply the roller ball 14 to selected parts of a patient's body for therapeutic effect. This application is accomplished by the following:

The roller ball 14 is able to rotate freely because it is held within the components described above. It does not fall out due to the construction of the middle encasement member 20. Specifically, the diameter of the middle encasement member at the narrow portion 45 is smaller than that of the widest portion of the roller ball 14, thus obstructing the roller ball's passing through the area.

The user can apply pressure and use the configurations to roll the roller ball 14 across parts of the body. This produces a massage effect.

The low or high temperature of the roller ball 14 changes the temperature of parts of the body on contact. This produces a cooling or heating effect.

When the configurable kit 100 or apparatus 10 is not in therapeutic use, the user may assemble the configurable apparatus as presented in FIG. 2 through similar methods as described earlier in this section. This configuration allows for the following:
1. Since the roller ball 14 is encased within the main roller body 12, the insulating properties of the three encasement members minimizes heat transfer so that the roller ball 14 retains its low or high temperature.
2. The flat surface 16s allows the user to place the assembled apparatus 10 onto a table, countertop or other convenient flat surface and have it remain static. Methods of Using the Kit

A first method of using the kit 100 involves a first step of placing the roller ball 14 inside of the hollow space 48 of the middle encasement member 20 so that the narrow portion 45 retains the roller ball therein.

The first method also includes a second step of engaging the third attachment structure 44 of the middle encasement member 20 with the fourth attachment structure 38 of the upper encasement member 18 to form the first therapeutic massage tool 50, wherein the roller ball 14 is retained within the tool by the narrow portion 45 of the middle encasement member.

A second method of using the kit 100 involves a first step of placing the roller ball 14 inside of the hollow space 48 of the middle encasement member 20 so that the narrow portion 45 retains the roller ball therein.

The second method also includes a second step of engaging the third attachment structure 44 of the middle encasement member 20 with the first attachment structure 24 of the lower encasement member to form the second therapeutic massage tool 60, wherein the roller ball 14 is retained within the tool by the narrow portion 45 of the middle encasement member..

Although the present invention has been described herein with respect to a number of specific illustrative embodiments, the foregoing description is intended to illustrate, rather than to limit the invention. Those skilled in the art will realize that many modifications of the illustrative embodiment could be made which would be operable. All such modifications, which are within the scope of the claims, are intended to be within the scope and spirit of the present invention.

### REFERENCE NUMERALS

Apparatus 10

Main roller body 12

Roller Ball: 14

Lower encasement member: 16

Flat surface of lower encasement member: 16s

Upper encasement member: 18

Middle encasement member: 20

Concave socket of lower encasement member 22

First attachment structure of lower encasement member: 24

Cup-like base of upper encasement member: 32

Concave socket of upper encasement member: 34

Handle portion of upper encasement member: 35

Hollow opening in handle portion: 36

Fourth attachment structure: 38

Middle ring of middle encasement member: 40

Second attachment structure of middle encasement member: 42

Third attachment structure of middle encasement member: 44

Narrow portion of middle encasement member: 45

Hollow cylindrical space within middle encasement member: 48

First massage tool 50

First diameter of the hollow cylindrical space: D1

Second diameter of the hollow cylindrical space: D2

Kit of components 100

I claim:

1. A configurable therapeutic massage roller apparatus, comprising a hollow main roller body and a roller ball housed within the main roller body,
the main roller body comprising a substantially cup-shaped lower encasement member, a modified goblet-shaped upper encasement member and a ring-shaped middle engagement member which is selectively attachable to the upper and lower encasement members,
the lower encasement member having a first concave opening formed therein and having a flattened lower surface, the lower encasement member having an upper edge portion with at least one first attachment structure thereon for connecting to the middle encasement member;
the middle encasement member having a hollow central opening formed therein, the middle encasement member also having a lower edge portion with a second attachment structure thereon for selectively connecting to the first attachment structure of the lower encasement member, the middle encasement member further having an upper edge portion with a third attachment structure thereon for selectively connecting to a fourth attachment structure of the upper encasement member;
wherein the hollow central opening of the middle engagement member has a first diameter at the upper edge portion thereof, and has a second diameter at the lower edge portion, the second diameter being less than the first diameter;
the upper encasement member comprising a cup-shaped portion having a second concave opening formed therein and having a handle attached to an upper end of the cup-shaped portion, the upper encasement member having a lower edge portion with at least one fourth attachment structure thereon for connecting to the middle encasement member;
wherein the ball is hollow and contains a thermally stable material therein.

2. The configurable therapeutic massage roller apparatus of claim 1, wherein the main roller body is formed from a plastic material.

3. The configurable therapeutic massage roller apparatus of claim 1, wherein each of the first, second, third and fourth attachment structures comprises threading.

4. The configurable therapeutic massage roller apparatus of claim 4, wherein the middle encasement member has an inner cylindrical surface which tapers inwardly at the lower end thereof.

5. The configurable therapeutic massage roller apparatus of claim 1, wherein the second attachment structure and the third attachment structure are substantially identical to one another.

6. The configurable therapeutic massage roller apparatus of claim 1, wherein the second attachment structure and the third attachment structure each comprise male threads which are substantially identical to one another.

7. A kit of components usable to selectively form therapeutic massage rollers, the kit comprising:
a hollow roller ball having a thermally stable material therein;
a substantially cup-shaped lower encasement member, the lower encasement member having a first concave opening formed therein and having a flattened lower surface, the lower encasement member having an upper edge portion with at least one first attachment structure thereon;
an upper encasement member comprising a cup-shaped portion having a second concave opening formed therein and having a handle attached to an upper end of the cup-shaped portion, the upper encasement member having at least one fourth attachment structure thereon for selectively connecting to the middle encasement member;
a substantially cylindrical middle encasement member having a hollow central opening formed therein, the middle encasement member also having a lower edge portion with a second attachment structure thereon for selectively connecting to the first attachment structure of the lower encasement member or to a fourth attachment structure of the upper encasement member, the middle encasement member further having an upper edge portion with a third attachment structure thereon and having a lower edge portion defining a narrow portion;
wherein the hollow central opening of the middle engagement member has a first diameter at the upper edge portion thereof, and has a second diameter at the lower edge portion, the second diameter being less than the first diameter.

8. A method of using the kit of claim 7, comprising the steps of:
a) placing the roller ball inside of the hollow space of the middle encasement member so that the narrow portion retains the roller ball therein;
b) engaging the third attachment structure of the middle encasement member with the fourth attachment structure of the upper encasement member to form a handled therapeutic massage tool, wherein the roller ball is retained within the tool by the narrow portion of the middle encasement member.

9. A method of using the kit of claim 7, comprising the steps of:
a) placing the roller ball inside of the hollow space of the middle encasement member so that the narrow portion retains the roller ball therein;
b) engaging the third attachment structure of the middle encasement member with the first attachment structure of the lower encasement member to form a therapeutic massage tool, wherein the roller ball is retained within the tool by the narrow portion of the middle encasement member.
